(19) United States
(12) Patent Application Publication
(10) Pub. No.: US 2010/0208469 A1
(43) Pub. Date: Aug. 19, 2010

(54) ILLUMINATION SURFACES WITH REDUCED LINEAR ARTIFACTS

(76) Inventor: Yosi Shani, Maccabim (IL)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/703,426

(22) Filed: Feb. 10, 2010

Related U.S. Application Data
(60) Provisional application No. 61/151,351, filed on Feb. 10, 2009.
(60) Provisional application No. 61/151,347, filed on Feb. 10, 2009.

(51) Int. Cl. F21V 17/02; F21S 8/00; F21V 7/00

(52) U.S. Cl. 362/322; 362/317; 362/319; 362/341

(57) ABSTRACT

Illumination surfaces according to the present invention eliminate or at least reduce linear “stitch” artifacts at edges between tiled illumination devices. As a result, light of substantially uniform intensity is emitted across the entire illumination system. This is achieved, in various embodiments, by reflecting, through the gaps between adjacent light-guide elements, light directed through the bottom surfaces of the elements.

### RELATED APPLICATION

This application claims priority to and the benefit of U.S. Provisional Patent Application Nos. 61/151,347 and 61/151,351, filed on Feb. 10, 2009, the entire disclosures of which are incorporated by reference herein.

### FIELD OF THE INVENTION

This invention relates to illumination systems, and in particular to systems involving adjacent lighting panels.

### BACKGROUND

Slim illumination systems are desirable for many illumination applications, and particularly for low-profile back-illuminated displays. A slim illumination system can be assembled by arranging many small lighting elements in an array. Each lighting element may be, for example, a light-guide panel having a light source that injects light into an “in-coupling” region of the panel and an illumination region where light is “out-coupled” from the light-guide element to provide illumination. In general, the light is emitted substantially uniformly across the illumination region.

In a typical array configuration, light-guide elements are arranged adjacently in longitudinal and lateral directions. Even if the light-guide elements are butted tightly together, gaps will remain between adjacent elements. Indeed, gaps are often provided intentionally to allow the light-guide elements to expand and contract as the ambient temperature varies without damaging the overall array configuration. Unfortunately, the intensity of light at or near a gap will typically differ from that emitted from the illumination regions. Therefore, the gaps may appear as “stitches”—i.e., relatively dark or light linear discontinuities—in the array. These artifacts are visible in both the longitudinal and lateral directions.

### SUMMARY OF THE INVENTION

Illumination devices according to the present invention eliminate or at least reduce the “stitch” effect. As a result, light of substantially uniform intensity is emitted across the entire slim illumination system. This can be achieved by reflecting, through the gaps between adjacent light-guide elements, light directed through the bottom surfaces of the elements. One or more mirrors may be disposed below the light-guide elements, and by adjusting the distance between the bottom surfaces and the mirror(s), the intensity of light reflected through the gap can blend unnoticeably with the light emitted from the illumination surfaces of the light-guide elements. The mirror-to-surface spacing may be adjustable to compensate, for example, for temperature changes, which can cause the light-guide elements to expand or contract and thereby change the gap width.

In a first aspect, embodiments of the invention relate to an illumination device that comprises a first light-guide element and a second light-guide element. Each light-guide element may include an illumination surface from which light is emitted, and a bottom surface opposite the illumination surface. The first and second light-guide elements are positioned such that there is a gap between the two light-guide elements, i.e., the light-guide elements may not be in contact with each other. One or more mirrors are positioned below the bottom surfaces of the light-guide elements and below the gap between them. The light-guide elements have externally reflective side walls (perpendicular to the illumination and bottom surfaces) that reflect light back into the gap.

In some embodiments of the illumination device, one or more mirrors are spaced apart from the bottom surfaces of the light-guide elements. One or more mirrors can be specular and one or more mirrors can be diffusive. The illumination device may also include two mirrors positioned such that a portion of one mirror overlaps a portion of the second mirror under the gap.

In another aspect, the invention relates to a planar illumination device comprising first and second light-guide elements each comprising an illumination surface and an opposed bottom surface, where the first and second light-guide elements are separated by a gap; at least one mirror in opposition to the bottom surfaces of the light-guide elements and underlying the gap; and a position changer for changing a position of the at least one mirror relative to the bottom surfaces of the light guide elements. This facilitates responsiveness to changes in the width of the gap. A position changer may, for example, respond to a change in temperature, e.g., by moving a mirror closer to the bottom surfaces when the temperature increases, and moving a mirror away from the bottom surfaces when the temperature decreases. The position changer can include an expandable element positioned below the mirror. The expandable element may expand when the temperature increases, thereby pushing the mirror towards the bottom surfaces of light-guide elements, and contract when temperature decreases, pulling the away from the bottom surfaces. Alternatively, the position changer may include one or more expandable elements and one or more fulcrums, positioned above the mirror.

In some embodiments, the first and second light-guide elements may each have a mirrored (i.e., externally reflecting) side wall facing the gap. The reflective side wall can be formed using a partially reflecting mirror, and the reflectivity of the partially reflecting mirror may vary along the length of the side wall.

One or more mirrors in the illumination device can be positioned at an angle with respect to the bottom surfaces, and the angle may be along a light-guiding direction i.e. an end of the mirror near the in-coupling region may be close to the bottom surfaces and the opposite end of the mirror, near the end wall of the light-guide element opposite to the in-coupling region, may be relatively at a greater distance from the bottom surfaces. Alternatively, the end of the mirror near the in-coupling region may be far from the bottom surfaces and the opposite end near the end wall may be at a relatively shorter distance from the bottom surfaces.

In some embodiments, the illumination device may include two or more mirrors positioned below the bottom surfaces of light-guide elements. One or more of these mirrors can be positioned substantially in parallel to the bottom surfaces, and one or more of these mirrors may be positioned at an angle with respect to the bottom surfaces. Alternatively, one or more of these mirrors may be positioned substantially in parallel to the bottom surface of the first light-guide element, and one or more mirrors can be positioned at an angle with respect to that bottom surface. The latter configuration can be employed when the bottom surfaces of the two light-guide elements may themselves be at an angle with respect to one another.

The bottom surfaces of the light-guide elements can have out-coupling features, which can influence the distribution of light from the bottom surface. For example, an out-coupling feature can vary the number of rays transmitted through the bottom surface and may also vary the angle at which such rays are transmitted. The out-coupling features can be bumps and/or grooves.

In a second aspect, embodiments of the invention relate to an illumination device that comprises a first light-guide element and a second light-guide element. Each light-guide element may include an illumination surface from which light is typically emitted, and a bottom surface opposite to the illumination surface. The first and second light-guide elements are positioned such that there is a gap between the two light-guide elements, i.e., the light-guide elements may not be in contact with each other. The first and second light-guide elements may each have a mirrored side wall facing the gap. The mirrored side wall can be formed using a partially reflecting mirror, and the reflectivity of the partially reflecting mirror may vary along the length of the side wall.

### LIST OF FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a plan view of light-guide elements arranged in an array to form an illumination area.

FIGS. 2A and 2B are plan and elevational views, respectively, of a single illumination element.

FIG. 3A is a sectional elevation of a portion of a light-guide element having convex bumps as bottom-surface out-coupling features.

FIG. 3B is a sectional elevation of a portion of a light-guide element having concave features as bottom-surface out-coupling features.

FIG. 4A is a sectional elevation schematically illustrating the behavior of light in connection with the embodiments shown in FIGS. 3A and 3B, using a single underlying mirror.

FIG. 4B is a sectional elevation schematically illustrating the behavior of light in connection with the embodiments shown in FIGS. 3A and 3B, using a pair of underlying mirrors that overlap beneath the gap between light-guide elements.

FIGS. 5A and 5B are partial sectional elevations schematically illustrating two temperature-responsive embodiments of the present invention.

FIG. 6 is a partial sectional elevation schematically illustrating an embodiment involving a tilted or angled mirror.

FIGS. 7A and 7B are plan and partial sectional elevations, respectively, of an embodiment involving blurring of stitch artifacts.

### DETAILED DESCRIPTION

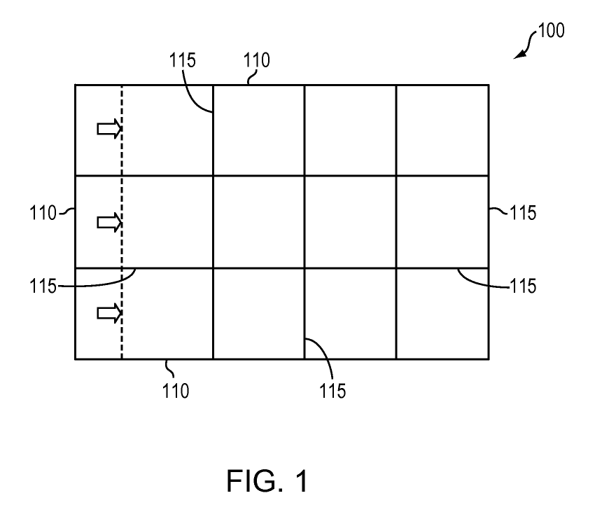

With reference to FIG. 1, an illumination surface 100 is formed by arranging a plurality of light-guide elements 110 in an array. In the surface 100, a plurality of gaps 115 occur between adjacent light guide elements 110. With changes in temperature, light-guide elements 110 can contract or expand, thereby changing the widths of the gaps 115 (which may be intentionally created to accommodate temperature-induced changes in the sizes of the light-guide elements 110). The dimensional response of the light-guide elements 110 to temperature depends on the material of the light-guide element, as well as the mechanical harness used to create the array 100. For polymer-based light-guide elements, the change along one dimension can be 0.1 mm per 25° C.

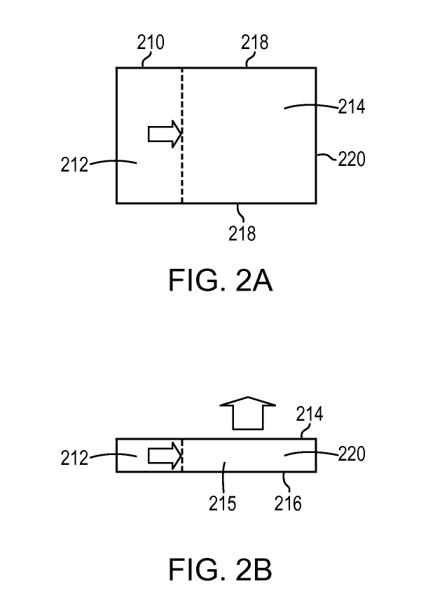

As shown in FIGS. 2A and 2B, an individual light-guide element 210 includes an in-coupling region 212, which receives light from a source such as a light-emitting diode (LED) (not shown); an illumination region 214; and opposite the illumination surface 214, a bottom surface 216. The light-guide element 210 also has side walls 218 and an end wall 220 distal to the in-coupling region 212. Light is generally emitted from the illumination surface 214. End wall 220 has a reflective coating so that light does not penetrate it; instead, it is retained within the light-guide element 210.

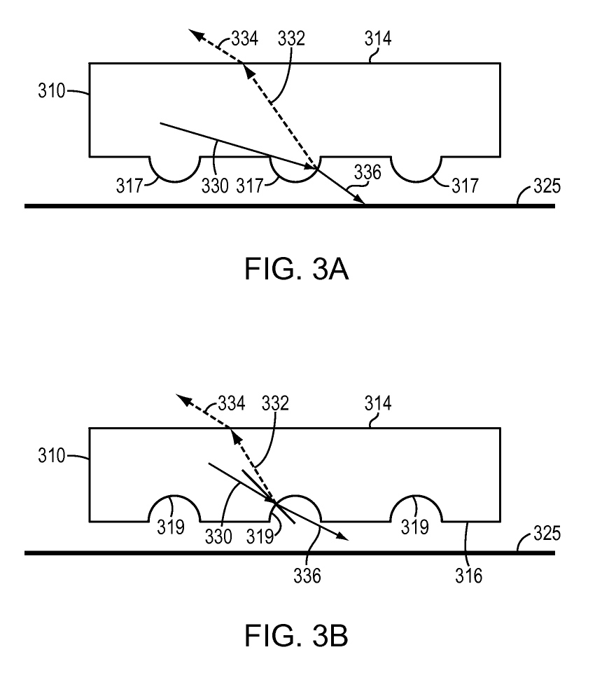

An embodiment of the present invention is shown in FIG. 3A. A light-guide element 310 has an illumination surface 314 and an opposed bottom surface 316 (as well as the other features, not illustrated here, that are shown in FIGS. 2A and 2B). A mirror 325 is positioned below the bottom surface 316. The bottom surface 316 has a series of bumps 317 as out-coupling features; that is, these features direct light traveling within the body of light-guide 310 out the bottom surface 316. Without the out-coupling bumps 317, light would not be emitted through bottom surface 316.

A ray of light 330 in the light-guide element 310 incident on a bump 317 may be reflected as ray 332 toward the illumination surface 314, in which case it may be emitted as ray 334 from the illumination surface 314. Alternatively, a ray 330 incident on bump 317 may be directed through the bottom surface as ray 336. Upon exiting the bottom surface 316, ray 336 may be reflected back into light-guide element 310 (i.e., through bottom surface 316) by mirror 325.

The light reflected by mirror 325 may be emitted subsequently from a gap between adjacent light-guide elements. In order for the intensity of light emitted from a gap to approximate the intensity of light emitted from the illumination surface 314, a certain amount of light (i.e., the number of light rays 336) must be directed through the bottom surface 316 toward mirror 325. In the light-guide element 310, bumps 317 on the bottom surface 316 may direct approximately 90% of light incident upon them through bottom surface 316.

An alternative structure is shown in FIG. 3B. In this embodiment, the bottom surface 316 has dents 319 as bottom-surface out-coupling features. Dents 319 may direct approximately 50% of light incident upon them through bottom surface 316.

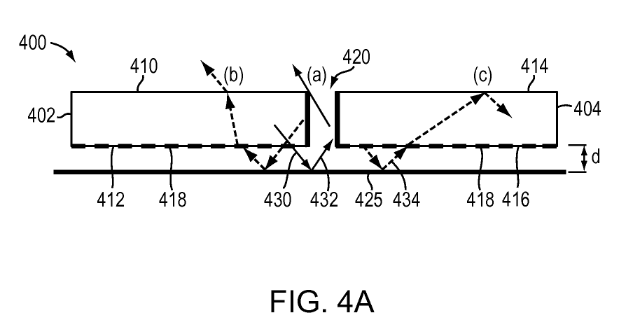

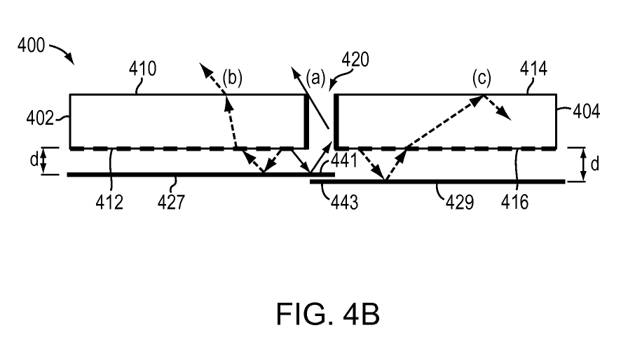

FIG. 4A illustrates the manner in which the embodiments shown in FIGS. 3A and 3B direct light through a gap between light-guide elements to hide stitch artifacts. Two light-guide elements 402, 404 are positioned adjacent each other. The light-guide element 402 has an illumination surfaces 410 and an opposed bottom surface 412. Similarly, light-guide element 404 has an illumination surface 414 and an opposed bottom surface 416. FIG. 4A schematically shows out-coupling features 418 generically (i.e., they can be bumps, grooves or both) on bottom surfaces 412 and 416. The light-guide elements 402, 404 are separated by a gap 420. A mirror 425 is positioned below the bottom surfaces 412, 416 and gap 420.

A ray of light reflected by mirror 425 through light-guide element 402 may be emitted as ray (b). On the other hand, a light ray reflected by mirror 425 through light-guide element 402 may be retained within the element 402 by total internal reflection, i.e., as ray (c). At least some of the rays striking mirror 425 due to out-coupling features 418 will be reflected into the gap 420 and emerge therefrom, as exemplified as ray (a). Because most of the light reflected into gap 420 will emerge as visible light, whereas only a portion of the light reflected into the light-guide elements 402, 404 is actually emitted through respective surfaces 410, 414 (the remainder being confined with one of the elements), the “extra” light through gap 420 can serve to hide or at least reduce the stitch artifact.

Thus, to achieve substantially uniform intensity of light across illumination surfaces 410, 414 and gap 420, the quantity of reflected light retained within elements 402, 404 (ray (c)) versus the quantity of reflected light emitted from elements 402, 404 (ray (b)), as well as the amount of light entering gap 420, may be adjusted by varying the distance d between mirror 425 and the bottom element surfaces 416, 418. If mirror 425 were placed in contact with bottom surfaces 412 and 416, relatively little light would be reflected by mirror 425 into gap 420, causing the gap to appear dark relative to illumination surfaces 410 and 414. If mirror 425 were situated too far from bottom surfaces 412, 416, too much light would be reflected by mirror 425 into gap 420, causing gap 420 to appear brighter than illumination surfaces 410, 414. By optimizing d, the light through gap 420 substantially matches the light emitted through illumination surfaces 410, 414.

As shown in FIG. 4B, two mirrors 427, 429 may be positioned below the bottom surfaces 412, 416, respectively, and overlap beneath gap 420. Specifically, a portion 443 of mirror 429 is positioned below a portion 441 of mirror 427. As mirrors 427 and 429 can be thin, the distance of mirror 427 from the bottom surface 412 can be substantially the same as the distance of mirror 429 from the bottom surface 416. Accordingly, the intensity of light emitted from gap 420 may be substantially the same as the intensity of light emitted from the illumination surfaces 410 and 414, eliminating or at least reducing the stitch artifact at gap 420.

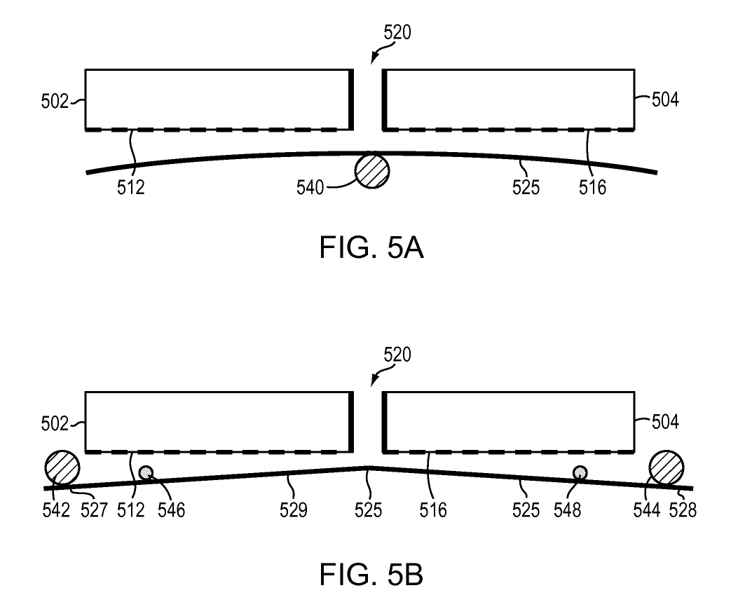

One limitation of these configurations is that they do not compensate for temperature-induced changes in the width of the gap. If the gap width changes, the amount of light emitted from the gap will also change unless the amount of light reflected into the gap is altered. While this may not be noticeable in some applications, it may well be in others. Two embodiments adapted to alter the amount of light reflected through the gap in a temperature-responsive manner are shown in FIGS. 5A and 5B, respectively.

In an embodiment shown in FIG. 5A, the light-guide elements 502, 504 have a gap 520 between them. A mirror 525 (e.g., a polished aluminum plate) is positioned below the bottom surfaces 512, 516 of light-guide elements 502, 504 and gap 520. An expansion element 540, which expands when temperature increases and contracts when temperature decreases, is positioned below and in contact with the underside of mirror 525. When the temperature increases, causing light-guide elements 502, 504 to expand, gap 520 narrows. But at the same time, expansion element 540 expands, pushing mirror 525 toward the bottom surfaces 512, 516 (the degree of mirror displacement depending on the temperature change). As explained above, as the distance between mirror 525 and bottom surfaces 512, 516 decreases, the amount of reflected light transmitted through gap 520 also decreases. But because gap 520 has become narrower, decreasing the “extra” light emitted through the gap has the effect of preventing overcorrection (and retaining a substantially similar light output across the entire illumination surface).

Conversely, when the temperature decreases, causing light-guide elements 502, 504 to contract, gap 520 widens. Contraction of expansion element 540 pulls mirror 525 away from the bottom surfaces 512, 516, increasing the amount of reflected light through the now-wider gap 520 to prevent undercorrection. Thus, both in the case of increased and decreased temperature, the amount of light emitted from gap 520 remains substantially the same as that obtained without the change in temperature.

Another approach to temperature correction is shown in FIG. 5B. A pair of expansion elements 542, 544 and a pair of fulcrums 546, 548 are positioned above mirror 525. As the temperature increases, expansion elements 542, 544 expand, pushing portions 527, 528 of mirror 525 away from the bottom surfaces 512, 516, respectively. As a result, a portion 529 of mirror 525 is pushed toward the bottom surfaces 512, 516, thereby decreasing the amount of light transmitted to gap 520. Conversely, when the temperature decreases, expansion elements 542, 544 contract, pulling portions 527, 528 of mirror 525 toward the bottom surfaces 512, 516, respectively, while pushing portion 529 of mirror 525 away from the bottom surfaces 512, 516. The effect of these movements is to increase the amount light reflected through gap 520. It should be noted that only portions of light-guide elements 502, 504 are shown in the figure; in general, mirror 525 will not extend beyond the boundaries of the light-guide elements.

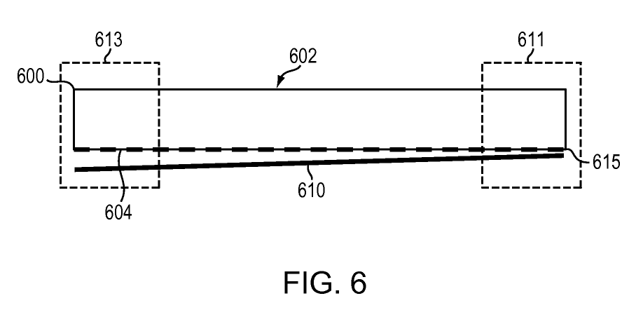

In some embodiments, the visibility of a stitch is reduced or eliminated by blurring the light emitted through the gap. With reference to FIG. 6, a mirror 610 is positioned below the bottom surface 604 of a light-guide element 600 at an angle relative to the bottom surface 604. Importantly, if the mirror passes beneath the gap, the angle underlies the width of the gap (i.e., the illustrated dimension) but there is no angle along the length of the gap (i.e., the dimension into the page); that is, the distance between the mirror and the plane defined by the bottom surfaces of the light-guide elements varies across, but not along, the gap. The angled position of mirror 610 can be achieved using fasteners or a transparent wedge (both not shown). Moreover, the illustrated embodiment involving one long wedge per light-guide element can be replaced by a “multi-wedge” structure in which multiple wedges, arranged along the width of the light-guide element, so that the light-to-dark variation occurs more than once along the light-guide element.

As described above, the amount of light transmitted to a gap (not shown) between adjacent light-guide elements increases or decreases as the distance between mirror 610 and the bottom surface 604 increases or decreases, respectively. Consequently, the amount of light reflected back into the light-guide element 600, and subsequently emitted from the illumination surface 602 of the light-guide element 600, changes in inverse relation to the distance between mirror 610 and the bottom surface 604.

Because mirror 610 is positioned at an angle relative to the bottom surface 604, its distance from the bottom surface 604 varies along the length of the bottom surface 604. This causes the amount of light reflected by mirror 610 into the light-guide element 600, and subsequently emitted through illumination surface 602, to vary along the length of the illumination surface 602. As a result, the “extra” light from mirror 610 emitted through the illumination surface 602 is not uniform, but varies gradually from relatively low in region 611 (where the distance between mirror 610 and bottom surface 604 is relatively small) to relatively high in region 613 (where the distance between mirror 610 and bottom surface 604 is relatively large). It should be noted that the in-coupling region of light-guide element 600 is at or beyond (i.e., to the right of) region 611.

As the ambient temperature changes, the gap width may change, as explained above. Because the position of mirror 610 is not altered in response to a temperature change in this embodiment, the intensity of light emitted from the gap may also change. But because the intensity of light emitted near the gap varies gradually, the stitch artifact may be less visible.

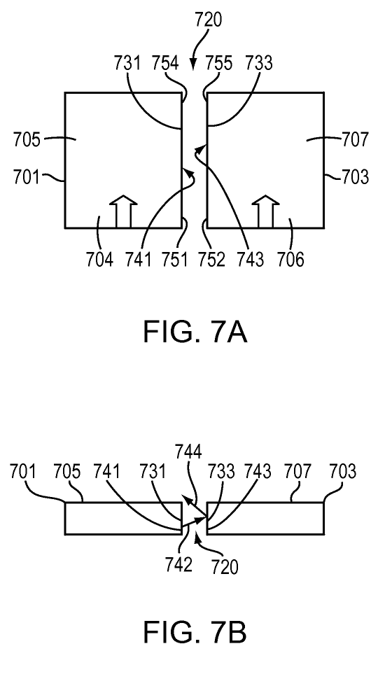

Another embodiment in which the visibility of stitch artifacts can be reduced by blurring is shown in FIGS. 7A and 7B. In this embodiment, the light-guide elements 701, 703 are separated by a gap 720, and have in-coupling regions 704, 706, respectively. A source of light (not shown) injects light into each in-coupling region. A side wall 731 of light-guide element 701, facing gap 720, is coated with a partially reflective mirror 741, and the opposed side wall 733 of light-guide element 703, facing gap 720, is also coated with a partially reflective mirror 743. A partially reflective coating can be formed, for example, by using a mirror coating having varying reflectivity, by introducing openings in the mirror, by varying the sizes of the openings, or by a combination of these techniques.

As illustrated in FIG. 7B, a light ray 742 transmitted through side wall 731 is reflected by the partially reflective mirror 743 and emitted from gap 720 as ray 744. By appropriately selecting the reflectivity of partially reflective mirrors 741, 743, the number of rays 742 transmitted to gap 720 and the number of rays 744 emitted from gap 720 can be adjusted. Accordingly, light emitted from gap 720 can be made substantially similar in intensity to light emitted from illumination surfaces 705, 707 of light-guide elements 701, 703. Thus, a stitch artifact near gap 720 can be reduced or eliminated. In this embodiment, the reflected light emerging through number of rays 742 transmitted to gap 720 does not change as gap width changes due to a change in temperature. Therefore, a stitch artifact may appear as a line along the length of gap 720 as temperature changes.

The artifact can be mitigated, however, by blurring the stitch line. To achieve this, the reflectivity of the partially reflective mirrors 741, 743 is varied along the length of gap 720. As shown in FIG. 7A, portions 751, 752 of mirrors 741, 743, respectively, have high reflectivity. Accordingly, the intensity of light emitted from gap 720 near the in-coupling regions 704, 706 is high, causing the gap 720 near the in-coupling regions 704, 706 to appear relatively bright. Conversely, portions 754, 755 of mirrors 741, 743, respectively, have low reflectivity. Accordingly, the intensity of light emitted from gap 720 near the end of the light-guide elements 701, 703 opposite the respective in-coupling regions 704, 706 is low, causing the gap 720 near these ends to appear relatively dark. Because the intensity of light emitted along the length of gap 720 is non-uniform, a stitch artifact does not appear as a line; instead it is blurred, thereby reducing its visibility.

Although the present invention has been described with reference to specific details, it is not intended that such details should be regarded as limitations upon the scope of the invention, except as and to the extent that they are included in the accompanying claims.

What is claimed is:

1. A planar illumination device comprising:
first and second light-guide elements each comprising an illumination surface, an opposed bottom surface, and a plurality of externally reflective side walls perpendicular to the illumination and bottom surfaces, the first and second light-guide elements being separated by a gap; and
at least one mirror in opposition to the bottom surfaces of the light-guide elements and underlying the gap.

2. The planar illumination device of claim 1, wherein the at least one mirror is spaced apart from the bottom surfaces of the light guide elements.

3. The planar illumination device of claim 1, wherein the at least one mirror comprises first and second mirrors.

4. The planar illumination device of claim 3, wherein at least a portion of the second mirror overlaps with a portion of the first mirror under the gap.

5. A planar illumination device comprising:
first and second light-guide elements each comprising an illumination surface and an opposed bottom surface, the first and second light-guide elements being separated by a gap;
at least one mirror in opposition to the bottom surfaces of the light-guide elements and underlying the gap; and
a position changer for changing a position of the at least one mirror relative to the bottom surfaces of the light guide elements.

6. The planar illuminating area of claim 5, wherein the position changer is responsive to temperature.

7. The planar illumination device of claim 5, wherein the position changer includes an expandable element positioned below the mirror.

8. The planar illumination device of claim 5, wherein the position changer comprises at least one expandable element and at least one fulcrum positioned above the mirror.

9. The planar illumination device of claim 1, wherein each of the first and second light-guide elements has a side wall facing the gap, the side walls being externally reflective to reflect light into the gap.

10. The planar illumination device of claim 9, wherein each reflective side wall is a partly reflecting mirror whose reflectivity varies along a length thereof.

11. The planar illumination device of claim 1, wherein the at least one mirror is angled relative to the bottom surfaces.

12. The planar illumination device of claim 6, wherein the angle is along a light-guiding direction.

13. The planar illumination device of claim 1, wherein the at least one mirror is a specular mirror.

14. The planar illumination device of claim 1, wherein the at least one mirror is a diffusive mirror.

15. The planar illumination device of claim 1, wherein the bottom surfaces of the light-guide elements comprise out-coupling features.

16. The planar illumination device of claim 19, wherein the out-coupling features comprise bumps.

17. The planar illumination device of claim 20, wherein the out-coupling features comprise grooves.

18. A planar illumination device comprising:
first and second light-guide elements separated by a gap, each light-guide element comprising:
an illumination surface;
an opposed bottom surface; and
an externally reflective side wall facing the gap.

19. The planar illumination device of claim 18, wherein each reflective side wall is a partly reflecting mirror whose reflectivity varies along a length thereof.

20. A method of illumination comprising the steps of:
providing first and second light-guide elements each comprising an illumination surface and an opposed bottom surface, the first and second light-guide elements being separated by a gap;
providing at least one mirror in opposition to the bottom surfaces of the light-guide elements and underlying the gap; and
changing a position of the at least one mirror relative to the bottom surfaces of the light guide elements in response to changes in a width of the gap.
